(19) United States
(12) Patent Application Publication
(10) Pub. No.: US 2019/0367036 A1
(43) Pub. Date: Dec. 5, 2019

(54) REMOTE AUTONOMOUS VEHICLE RIDE SHARE SUPERVISION

(71) Applicant: Ford Motor Company, Dearborn, MI (US)

(72) Inventors: Ronald Patrick BROMBACH, Plymouth, MI (US); Daniel M. KING, Northville, MI (US); John Robert VAN WIEMEERSCH, Novi, MI (US)

(21) Appl. No.: 16/461,083

(22) PCT Filed: Nov. 22, 2016
(86) PCT No.: PCT/US2016/063230

§ 371 Date: May 15, 2019

(51) Int. Cl. B60W 40/08; G06K 9/00; B60R 25/24; B60R 25/30; G06Q 50/30; G07C 5/00

(52) U.S. Cl. CPC B60W 40/08; G06K 9/00832; B60R 25/24; B60R 25/305; B60R 2325/205; G07C 5/008; B60W 2040/0809; B60W 2540/28; G06Q 50/30

(57) ABSTRACT

A vehicle computer includes a processor programmed to confirm an identity of a limited user prior to permitting the limited user to enter an autonomous host vehicle, monitor autonomous operation of the host vehicle, and transmit a status update to a primary mobile device associated with a supervisor user of the host vehicle during autonomous operation of the autonomous host vehicle.

### BACKGROUND

The Society of Automotive Engineers (SAE) has defined multiple levels of autonomous vehicle operation. At levels 0-2, a human driver monitors or controls the majority of the driving tasks, often with no help from the vehicle. For example, at level 0 (“no automation”), a human driver is responsible for all vehicle operations. At level 1 (“driver assistance”), the vehicle sometimes assists with steering, acceleration, or braking, but the driver is still responsible for the vast majority of the vehicle control. At level 2 (“partial automation”), the vehicle can control steering, acceleration, and braking under certain circumstances without human interaction. At levels 3-5, the vehicle assumes more driving-related tasks. At level 3 (“conditional automation”), the vehicle can handle steering, acceleration, and braking under certain circumstances, as well as monitoring of the driving environment. Level 3 requires the driver to intervene occasionally, however. At level 4 (“high automation”), the vehicle can handle the same tasks as at level 3 but without relying on the driver to intervene in certain driving modes. At level 5 (“full automation”), the vehicle can handle almost all tasks without any driver intervention. Level 5 automation allows the autonomous vehicle to operate as a chauffeur, which is helpful for passengers who cannot otherwise operate a vehicle.

### BRIEF DESCRIPTION OF THE DRAWINGS

FIG. 1 illustrates an example host vehicle with a vehicle computer that allows a supervisor user to have control over certain autonomous operations when used by a limited user.

FIG. 2 is a block diagram of example vehicle components incorporated into or that operate in accordance with the vehicle computer.

FIG. 3 is a table showing various controls available to the supervisor user and the limited user.

FIG. 4 is a flowchart of an example process that may be executed by the vehicle computer.

### DETAILED DESCRIPTION

A fully autonomous vehicle can be used to transport passengers who cannot otherwise operate a vehicle. For example, a parent may send the autonomous vehicle to transport his or her children to, e.g., school, extracurricular activities, sporting events, a friend or relative's house, home, etc. The parent may wish to monitor or control certain aspects of such trips. For instance, the parent may wish to have a final say in the vehicle destination, the route taken to the destination, the number of passengers, who is permitted to enter the vehicle, etc. Although described in the parent/child context, a similar notion applies where the vehicle owner wishes to maintain control certain autonomous vehicle operations relative to other passengers who use the vehicle in, e.g., a ride share context.

One way to give the parent (or other vehicle owner) control over certain autonomous operations, even when the parent is not in the vehicle while it is operating autonomously, is to establish various user profiles, each with different levels of authorization. The profile with the highest level of authorization may be referred to as a supervisor user profile. The supervisor profile may apply to the parent or another vehicle owner (referred to below as the supervisor user). The profile with a lower level of authorization may be referred to as a limited user profile. The limited user may be a child of the supervisor user, an employee of the supervisor user, or another person permitted to use the vehicle other than the supervisor user. The authorizations associated with each profile are discussed in greater detail below.

An example vehicle computer that gives a supervisor user control over certain autonomous operations performed while a limited user is using the vehicle, even when the supervisor user is not in or near the vehicle, includes a processor programmed to confirm an identity of the limited user prior to permitting the limited user to enter an autonomous host vehicle, monitor autonomous operation of the host vehicle, and transmit a status update to a primary mobile device associated with the supervisor user of the host vehicle during autonomous operation of the autonomous host vehicle.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

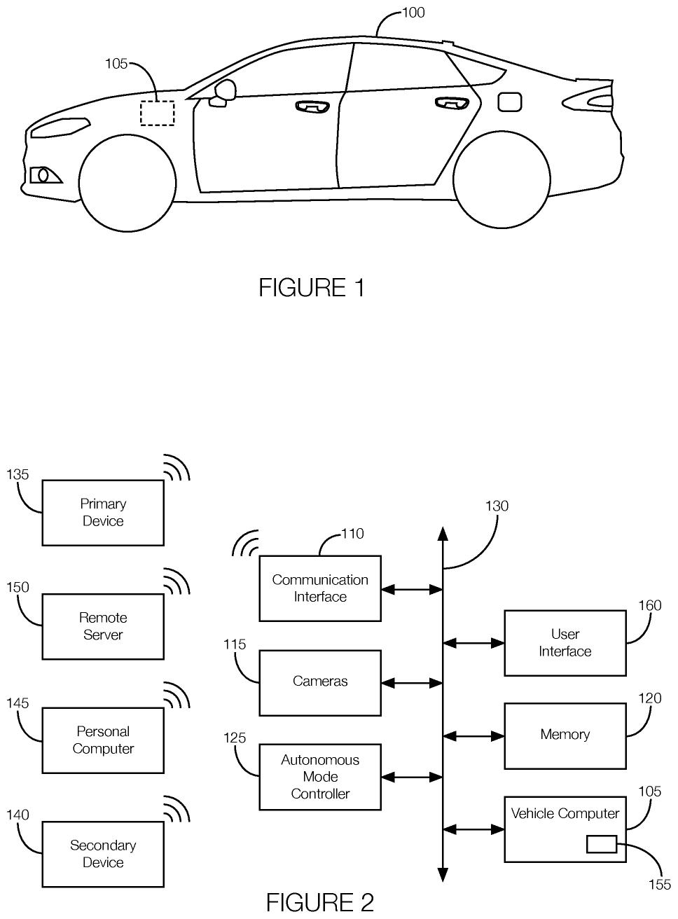

As illustrated in FIG. 1, an autonomous host vehicle 100 includes a vehicle computer 105 that can confirm an identity of a limited user prior to permitting the limited user to entering the host vehicle 100, monitor autonomous operation of the host vehicle 100, and transmit a status update to a primary mobile device (see FIG. 2) associated with a supervisor user of the host vehicle 100 during autonomous operation of the autonomous host vehicle 100. The vehicle computer 105 can also receive and process communications transmitted form a secondary mobile device (see FIG. 2) associated with a limited user, as discussed in greater detail below. The supervisor user may be an owner of the host vehicle 100 and the limited user may be someone given temporary authority to use the host vehicle 100. The limited user, therefore, may be a child, friend, or employee of the supervisor user.

Although illustrated as a sedan, the host vehicle 100 may include any passenger or commercial automobile such as a car, a truck, a sport utility vehicle, a crossover vehicle, a van, a minivan, a taxi, a bus, etc. Moreover, the host vehicle 100 is an autonomous vehicle that can operate in an autonomous (e.g., driverless) mode, a partially autonomous mode, and/or a non-autonomous mode.

Referring now to FIG. 2, the vehicle computer 105 operates in accordance with other vehicle components such as a communication interface 110, cameras 115, a memory 120, an autonomous mode controller 125, and a user interface 160 in communication with one another over a communication network 130, such as a controller area network (CAN) bus, Ethernet, Local Interconnect Network (LIN), and/or any other wired or wireless communications network.

The communication interface 110 is implemented via an antenna, circuits, chips, or other electronic components that can communicate with various electronic devices through a wired or wireless communication link. For instance, the communication interface 110 may be programmed to facilitate wireless communication between the vehicle computer 105 and a primary mobile device 135 associated with a supervisor user, a personal computer 145 associated with a supervisor user, a secondary mobile device 140 associated with a limited user, and one or more remote servers 150. The communication interface 110 may be programmed to communicate with various components of the host vehicle 100, such as the vehicle computer 105, the memory 120, the autonomous mode controller 125, etc., over the communication network 130. Thus, signals received from the primary mobile device 135, the secondary mobile device 140, or the remote server 150 may be forwarded to, e.g., a processor 155 of the vehicle computer 105. The communication interface 110 may be programmed to communicate in accordance with any number of wireless communication protocols such as Bluetooth®, Bluetooth® Low Energy, WiFi, or any cellular or satellite-based communication protocol. Moreover, the communication interface 110 may be programmed to communicate over the communication network 130 via CAN, Ethernet, LIN, or other wired communication protocols.

The primary mobile device 135 and secondary mobile device 140 are electronic devices, such as smartphones, tablet computers, etc., that can receive user inputs entered into the primary mobile device 135 or the secondary mobile device 140 through a user interface (e.g., a keyboard, touchscreen, etc.). The primary mobile device 135 and secondary mobile device 140 are programmed to communicate over any number of wired or wireless communication protocols. For instance, the primary mobile device 135 and secondary mobile device 140 may communicate with the communication interface 110, the remote server 150, or both, via Bluetooth®, Bluetooth® Low Energy, WiFi, or any cellular or satellite-based communication protocol.

The personal computer 145 is an electronic computing device implemented via circuits, chips, or other electronic components that can communicate with the remote server 150. For instance, the personal computer 145 may be a laptop computer, a desktop computer, a tablet computer, etc. The personal computer 145 may be programmed to communicate with the remote server 150 over a network such as the internet or a cellular telecommunications network.

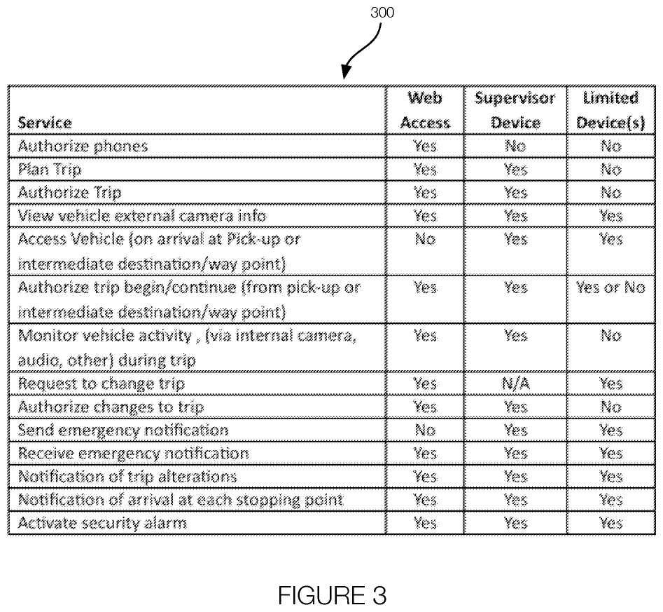

The remote server 150 is an electronic computing device implemented via circuits, chips, or other electronic components that can store data, such as a supervisor profile associated with the supervisor user, a limited profile associated with the limited user, etc. The remote server 150 may make such data available to certain electronic devices in response to queries transmitted from those devices. For instance, the remote server 150 may make the supervisor profile available to the primary mobile device 135, the secondary mobile device 140, the personal computer 145, the vehicle computer 105, or a combination thereof. Examples of data stored in the supervisor profile and limited profile are discussed in greater detail below with regard to FIG. 3. Further, the remote server 150 may be programmed to receive profile updates from the personal computer 145, the primary mobile device 135, and possibly the secondary mobile device 140. Examples of data that can be updated by the personal computer 145, the primary mobile device 135, and possibly the secondary mobile device 140 are discussed below with reference to FIG. 3.

The user interface 160 is an electronic computing device implemented via circuits, chips, or other electronic components that can present information inside the host vehicle 100 via a display screen, receive user inputs provided to real or virtual buttons located in the host vehicle 100, or both. In some possible implementations, the user interface 160 includes a touch-sensitive display screen. In some instances, the user interface 160 may be programmed to receive user inputs associated with various autonomous vehicle operations. The user interface 160, therefore, may be programmed to receive user inputs that may otherwise be provided via the primary mobile device 135, the secondary mobile device 140, or the personal computer 145.

The cameras 115 are electronic device implemented via circuits, chips, an image sensor, or other electronic components that can capture electronic or digital images. The cameras 115 are located in or around the host vehicle 100 and can capture images of people or objects in and around the host vehicle 100. The cameras 115 may each output signals representing the digital images captured. The signals may be output to the processor 155 or the memory 120 via, e.g., the communication network 130. In some instances, the cameras 115 are part of an occupant detection system.

The memory 120 is implemented via circuits, chips, or other electronic components that can electronically store data. The data stored in the memory 120 may include instructions executed by the vehicle computer 105, and specifically the processor 155, or other components of the host vehicle 100. In some instances, the memory 120 may also or alternatively refer to a local memory 120 for storing, e.g., the permissions or other data associated with the supervisor user, the limited user, etc.

The autonomous mode controller 125 is implemented via circuits, chips, or other electronic components that can control certain autonomous operations of the host vehicle 100. For instance, the autonomous mode controller 125 may receive signals output by autonomous driving sensors (such as LIDAR sensors, radar sensors, ultrasonic sensors, cameras 115, etc.), process the sensor signals, and output control signals to, e.g., various actuators that control the steering, acceleration, and braking of the autonomous host vehicle 100.

The vehicle computer 105 is an electronic computing device implemented via circuits, chips, or other electronic components. For instance, the vehicle computer 105 includes a processor 155 programmed to confirm an identity of a limited user prior to permitting the limited user to enter an autonomous host vehicle 100, monitor autonomous operation of the host vehicle 100, and transmit a status update to a primary mobile device 135 associated with a supervisor user of the host vehicle 100 during autonomous operation of the autonomous host vehicle 100.

The processor 155 may be programmed to confirm the identity of the limited user based on, e.g., the detection of the secondary mobile device 140 in or near the host vehicle 100. That is, the secondary mobile device 140 may wirelessly pair with the communication interface 110 when the secondary mobile device 140 is near the host vehicle 100. The communication interface 110 may output a signal to the processor 155, over the communication network 130, indicating that the secondary mobile device 140 is connected to the host vehicle 100. The processor 155 may determine that the secondary mobile device 140 is associated with the limited user based on data from the limited profile retrieved from the remote server 150 and stored, at least temporarily, in the memory 120. In another possible approach, the processor 155 may confirm the identity of the limited user via the images captured by the cameras 115. After the identity of the limited user is confirmed, the processor 155 may output a control signal to a door lock actuator to, e.g., unlock one or more doors of the host vehicle 100 to permit the limited user to enter the host vehicle 100 through the unlocked door.

The processor 155 is programmed to control certain autonomous vehicle operations according to the permissions associated with the limited user as granted by the supervisor user. Controlling certain autonomous operations includes the processor 155 being programmed to output control signals to the autonomous mode controller 125. For instance, the processor 155 may be programmed to only permit the host vehicle 100 to operate in an autonomous mode only after confirming the identity of the limited user and after the limited user has entered the host vehicle 100. Thus, one way for the processor 155 to control the autonomous vehicle operations is to output signals indicating whether certain autonomous vehicle operations are permitted and when such operations are permitted. The processor 155 may make decisions concerning the autonomous vehicle operations according to the data stored in the supervisor profile, the limited profile, or both.

The limited user may wish to make certain changes to the autonomous vehicle operations. The processor 155 may be programmed to determine which permissions are granted to the limited user and either permit or deny any changes accordingly. For instance, the processor 155 may command the communication interface 110 to query the remote server 150 for the permissions associated with the limited profile, the supervisor profile, or both. In some instances, the processor 155 may access the permissions associated with the limited profile, the supervisor profile, or both, from the memory 120. The processor 155 may determine, from the permissions, whether the limited user can make changes to the autonomous vehicle operations, whether the changes require approval from the supervisor user, etc.

In some instances, the permissions may be specific to particular autonomous vehicle operation, as discussed in greater detail below with regard to FIG. 3. The processor 155 may be programmed to determine, from the limited profile, the permissions granted to the limited user for the autonomous vehicle operation the limited user wishes to adjust. If the change is permitted by the supervisor user or if the permissions granted by the supervisor user permit the limited user to make the change, the processor 155 may be programmed to permit the change to the autonomous vehicle operations. Otherwise, the processor 155 may deny or ignore the request to change the autonomous vehicle operation.

If the adjustment requires prior approval from the supervisor user, the processor 155 may be programmed to command the communication interface 110 to transmit a message to the primary mobile device 135 requesting approval for the adjustment and wait for the response from the primary mobile device 135. If the request for approval is denied or if no response is received within a predetermined period of time, the processor 155 may deny or ignore the request. If the approval is received, the processor 155 may permit the adjustment by, e.g., outputting a signal to the autonomous mode controller 125 notifying the autonomous mode controller 125 of the change, approval for the change, or both.

The processor 155 may be further programmed to transmit status updates to the primary mobile device 135 while the limited user is using the host vehicle 100. The processor 155 may transmit status updates by commanding the communication interface 110 to transmit data to the primary mobile device 135. The status updates may indicate that the limited user has entered the host vehicle 100, the number of passengers in the host vehicle 100, the destination of the host vehicle 100, the current location of the host vehicle 100, the speed of the host vehicle 100, that the host vehicle 100 has arrived at the destination, that the host vehicle 100 has arrived at the pickup location, etc. The processor 155 may be programmed to transmit the status updates periodically, in response to certain milestones, in response to a request for a status update received from the primary mobile device 135, etc. Examples of milestones may include when the host vehicle 100 arrives at a pickup location to pick up the limited user, when the host vehicle 100 arrives at a destination, when the limited user enters the host vehicle 100, when the limited user unlocks the doors of the host vehicle 100, when the number of occupants in the host vehicle 100 exceeds a predetermined value, etc.

In some instances, the processor 155 may be programmed to command the communication interface 110 to transmit images captured by the camera 115 to the primary mobile device 135. The images may be captured periodically or in response to a request for the images received from the primary mobile device 135. In some possible approaches, the processor 155 may command the communication interface 110 to transmit the images unsolicited to the primary mobile device 135. For instance, the processor 155 may process the images and determine that the number of occupants in the host vehicle 100 exceeds a predetermined value (e.g., the host vehicle 100 is being used to transport more passengers than the supervisor user has permitted). Under this circumstance, the processor 155 may command the communication interface 110 to transmit the images to the primary mobile device 135 and await further instruction.

Another possible implementation includes the processor 155 being programmed to require the limited user to face the camera 115 prior to the processor 155 permitting entry to the host vehicle 100. The processor 155 may be programmed to transmit an image of the limited user's face to the primary mobile device 135 so that the supervisor user can authenticate the limited user and permit access to the host device via a user input provided to the primary mobile device 135 and transmitted to the processor 155 via the communication interface 110 and communication network 130. Alternatively, or in addition, the processor 155 may perform an image processing technique on the image to determine if the person at the host vehicle 100 is the limited user and may unlock the doors of the host vehicle 100 without any additional approval from the supervisor user if the passenger is determined, by the processor 155, to be the limited user.

FIG. 3 is a table 300 illustrating example autonomous vehicle operations and whether the supervisor user or the limited user can adjust the autonomous vehicle operations. Moreover, the table 300 indicates whether the supervisor user can adjust the autonomous vehicle operation via the personal computer 145 (e.g., the “Web Access” column) or via the primary mobile device 135 (e.g., the “Supervisor Device” column). The table 300 further indicates which autonomous vehicle operations can be adjusted by the limited user (e.g., the “Limited Device(s)” column) via the secondary mobile device 140.

The list of autonomous vehicle operations shown in the table 300 includes authorizing secondary mobile devices 140 (to, e.g., authorize particular limited users); planning a trip including setting a pickup location, a destination, and a route; authorizing a trip to begin navigating to the destination; accessing the host vehicle 100 at the pickup location or a waypoint along the route (e.g., unlocking the vehicle doors); monitoring vehicle activity via, e.g., the camera 115 or vehicle microphone, etc., during the trip; requesting changes to the trip (e.g., adding a waypoint, changing the destination, changing the route to the destination, etc.); authorizing changes to the trip; sending emergency notifications; receiving emergency notifications; receiving notifications of trip alterations; receiving a notification that the host vehicle 100 has arrived at a particular waypoint along the route; and activating a security alarm.

As indicated in the table 300, the supervisor user can control all autonomous vehicle operations listed except for accessing the vehicle and sending emergency notifications via the personal computer 145. For instance, the supervisor user may use the personal computer 145 to log into a web page that permits the supervisor user to control the autonomous vehicle operations identified, and possibly others. The supervisor user may be able to further control certain autonomous vehicle operations from his or her primary mobile device 135, and those autonomous vehicle operations may be a different subset than those that the supervisor user can control via the personal computer 145. For instance, as shown in the table 300, the supervisor user cannot authorize limited users or secondary mobile devices 140 via the primary mobile device 135 but is able to send emergency notifications and provide credentials to access the host vehicle 100 via the primary mobile device 135.

The limited user can also control certain autonomous vehicle operations from the secondary mobile device 140, although the subset of autonomous vehicle operations available for the limited user to control is different from the subset of operations available to the supervisor user, regardless of whether the supervisor user is using the personal computer 145 or the primary mobile device 135. As shown in the table 300, the limited user cannot authorize additional limited users, plan trips, authorize trips, monitor vehicle activity, or authorize change to the trip. The limited user can adjust or initiate other autonomous vehicle operations, however, including viewing external camera 115 images, accessing (e.g., unlocking the door and entering) the host vehicle 100, sending emergency notifications, receiving emergency notifications, receiving notifications of trip alterations, receiving notifications that the host vehicle 100 has arrived at a particular waypoint, and activating a security alarm.

Some or at least a subset of the permissions shown in the “Limited Device(s)” column of the table 300 may be changed by the supervisor user via the personal computer 145. For instance, in the table 300, the supervisor user may allow the limited user to authorize the trip to begin via the secondary mobile device 140. Alternatively, the supervisor user may not want the limited user to be able to authorize trips. Therefore, the table 300 shows “Yes or No” for that autonomous vehicle operation. The table 300 may be updated after the supervisor user has decided whether to allow the limited user to have control over that autonomous vehicle operation.

In another possible approach, the “Yes or No” may indicate that the supervisor user has to approve the adjustment to the autonomous vehicle operation. Therefore, an entry of “Yes or No” may indicate that the supervisor user must approve the change in the autonomous vehicle operation before the host vehicle 100 will implement the change. Thus, in the example table 300, if the limited user, via the secondary mobile device 140, authorizes the trip to begin, the host vehicle 100 may send a request to the personal computer 145, the primary mobile device 135, or both to approve the trip to begin. In this example, the trip may begin only after the approval is received from the supervisor user via the personal computer 145 or the primary mobile device 135.

Moreover, the user interface 160 located in the host vehicle 150 may serve as an alternative to the primary mobile device 135, the secondary mobile device 140, the personal computer 145, or a combination thereof. Thus, certain the autonomous vehicle operations may be controlled in the host vehicle 100 by a passenger that does not have the primary mobile device 135, the secondary mobile device 140, or the personal computer 145. The user interface 160 may be programmed to prompt the user to provide certain credentials to confirm that the user is the supervisor user and not a limited user. Once confirmed, the user interface 160 may present options and receive user inputs associated with the authorizations granted to the confirmed supervisor user via the primary mobile device 135, the personal computer 145, or both. Since different limited users may have different authorizations, the user interface 160 may prompt the limited user to provide credentials to confirm his or her identity. Upon confirmation of a limited user, the user interface 160 may present options and receive user inputs associated with the authorizations granted to the confirmed limited user.

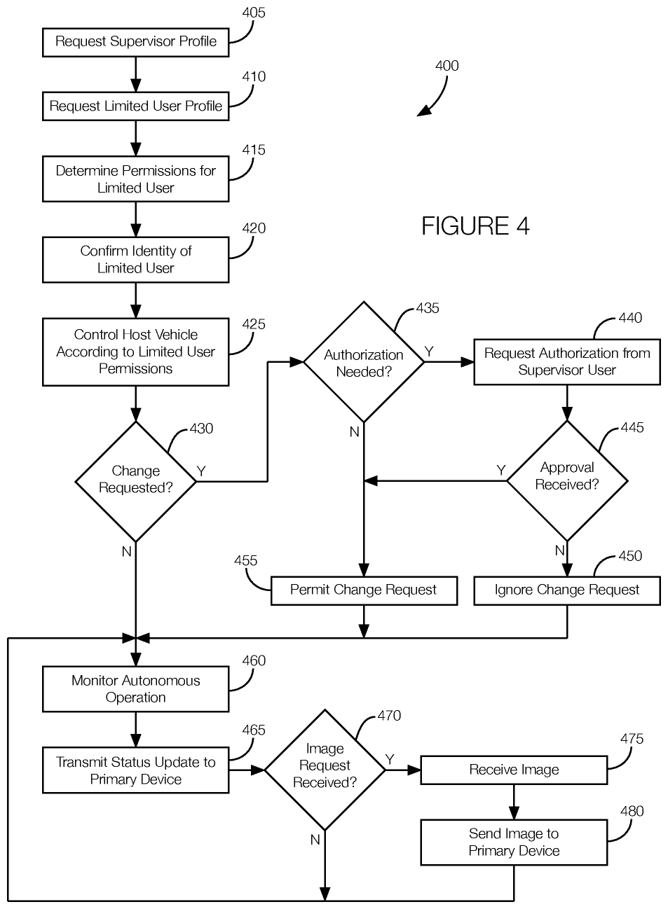

FIG. 4 is a flowchart of an example process 400 that may be executed by the vehicle computer 105 to handle certain autonomous vehicle operations in accordance with permissions granted to a limited user of the host vehicle 100. The process 400 may begin prior to the limited user entering the host vehicle 100 and may continue to execute until after the limited user exits the host vehicle 100.

At block 405, the vehicle computer 105 requests a supervisor profile. The processor 155 may command the communication interface 110 to transmit a query to the remote server 150 for the supervisor profile associated with the host vehicle 100.

At block 410, the vehicle computer 105 requests a limited profile. The processor 155 may command the communication interface 110 to transmit a query to the remote server 150 for the limited profile associated with the next limited user of the host vehicle 100.

At block 415, the vehicle computer 105 determines permissions for the limited user. The processor 155 may process the response received from the remote server 150 following the queries transmitted at blocks 405 and 410 to determine the permissions of the limited user relative to various autonomous vehicle operations.

At block 420, the vehicle computer 105 confirms the identity of the limited user. For instance, the limited user may be instructed, via the secondary mobile device 140, to approach the host vehicle 100. The communication interface 110 may pair with the secondary mobile device 140 and output a signal to the processor 155 indicating that the communication interface 110 has paired with the secondary mobile device 140. The processor 155 may confirm the identity of the limited user in response to receiving such a signal. An alternative way to confirm the identity of the limited user is for the processor 155 to process an image captured by a camera 115 with a view outside the host vehicle 100.

If the identity of the limited user cannot be confirmed at block 420, the process 400 may end at that block. The processor 155 may be unable to confirm the identity of the limited user if the person attempting to access the host vehicle 100 is not authorized to access the host vehicle 100. In such instances, the processor 155 will lock the doors of the host vehicle 100 (or keep the doors locked) and roll up any windows that may be down by, e.g., outputting a signal to a body control module to actuate the door locks and actuate the window motors. In some instances, such as if the doors were previously unlocked or one or more windows were down, the processor 155 may be programmed to output a signal that commands the cameras 115 to capture images from inside the host vehicle 105. The images may capture images of the seats, floorboards, etc., and transmit the images, with an alert, to the remote server 150, the primary mobile device 135, the personal computer 145, or a combination thereof. The supervisor user may receive the alert and review the images to determine what, if any, action should be taken. The supervisor user may provide a user input to the primary mobile device 135 or the personal computer 145 with an instruction for, e.g., commanding the host vehicle 100 to proceed to a police station (if, e.g., there is an unauthorized person or animal in the host vehicle 100), commanding the host vehicle 100 to proceed to a different location, etc. In some instances, the supervisor user may use the primary mobile device 135 or personal computer 145 to notify the police to proceed to the location of the host vehicle 100. In instances where the supervisor user is not the owner of the host vehicle 100, the supervisor user may use the primary mobile device 135 or personal computer 145 to call the owner to investigate why an unauthorized person is in the host vehicle 100. In some instances, the supervisor user may override the processor 155 and command the processor 155 to allow the person to enter the host vehicle 100. For instance, the supervisor user may provide a user input to the primary mobile device 135 or personal computer 145 indicating that the person is authorized (i.e., the person is indeed a limited user) and representing the identity of the limited user. Under this circumstance, the process 400 may proceed to block 425.

At block 425, the vehicle computer 105 controls the host vehicle 100 according to the permissions associated with the limited user. The processor 155 may output control signals to the autonomous mode controller 125 that indicate what autonomous vehicle operations are permitted to occur given the permissions granted to the limited user.

At decision block 430, the vehicle computer 105 determines if a change in one or more of the autonomous vehicle operations has been requested. The request may be transmitted by the secondary mobile device 140 in response to a user input entered into the secondary mobile device 140. The request may be received by the communication interface 110 and transmitted to the processor 155. If the change request is received, the process 400 may proceed to block 435. If no change request is received, the process 400 may proceed to block 460.

At decision block 435, the vehicle computer 105 determines if authorization for the change request is needed. The processor 155 may determine whether authorization is needed based on the permissions associated with the limited user. Examples of certain autonomous vehicle operations that can be executed without authorization are discussed above with reference to the table 300 of FIG. 3. If authorization is needed, the process 400 may proceed to block 440. If authorization is not needed, the process 400 may proceed to block 455.

At block 440, the vehicle computer 105 requests authorization from the supervisor user. The processor 155 may command the communication interface 110 to transmit the request for authorization to the personal computer 145, primary mobile device 135, or both, associated with the supervisor user. The request may be transmitted from the communication interface 110 to the primary mobile device 135 or personal computer 145 in accordance with, e.g., a cellular or satellite communication protocol. In some instances, the processor 155 may instruct the communication interface 110 to transmit the request to the remote server 150, which may forward the request to the primary mobile device 135, the personal computer 145, or both. The remote server 150 may also make the request available via a web app accessible via the personal computer 145.

At decision block 445, the vehicle computer 105 determines if approval has been received. The processor 155 may determine whether approval has been received by monitoring communications received by the communication interface 110. When the approval from the personal computer 145 or primary remote device is received, the process 400 may proceed to block 455. If the change is denied, the process 400 may proceed to block 450. Block 455 may be executed iteratively for a predetermined amount of time or for a predetermined number of iterations until approval is received. If no approval is received within the predetermined amount of time or predetermined number of iterations, the process 400 may automatically proceed to block 450 without further waiting for the approval.

At block 450, the vehicle computer 105 ignores the change request. The processor 155 may do nothing or may instruct the autonomous mode controller 125 to continue the autonomous vehicle operations despite the change request. In some instances, a log of the change request and its denial may be stored in the memory 120.

At block 455, the vehicle computer 105 permits the change request. The processor 155 may permit the change request by outputting a signal to the autonomous mode controller 125 instructing the autonomous mode controller 125 to adjust the autonomous vehicle operation according to the change requested at block 430.

At block 460, the vehicle computer 105 monitors certain autonomous vehicle operations during the trip. For instance, the processor 155 may monitor whether the host vehicle 100 has arrived at a pickup location to pick up the limited user, whether the limited user has unlocked the doors of the host vehicle 100, whether the limited user has entered the host vehicle 100, the number of passengers in the host vehicle 100, whether the number of passengers exceeds a predetermined threshold, the destination of the host vehicle 100, the current location of the host vehicle 100, the speed of the host vehicle 100, whether the host vehicle 100 has arrived at the destination, whether the host vehicle 100 has arrived at the pickup location, etc.

At block 465, the vehicle computer 105 transmits a status update to the primary mobile device 135. For instance, the processor 155 may command the communication interface 110 to transmit the status update to the primary mobile device 135 periodically or at certain milestones. Examples of milestones may include when the host vehicle 100 arrives at a pickup location to pick up the limited user, when the host vehicle 100 arrives at a destination, when the limited user enters the host vehicle 100, when the limited user unlocks the doors of the host vehicle 100, when the number of occupants in the host vehicle 100 exceeds a predetermined value, etc. In addition or in the alternative, the status update may be transmitted to the remote server 150, which may make the status update available via the web app so that it can be accessed via the personal computer 145.

At decision block 470, the vehicle computer 105 determines whether an image request has been received. The image request may be transmitted from the primary mobile device 135 to the communication interface 110 and may request an image of an interior of the host vehicle 100. The image may indicate who is in the host vehicle 100. The communication interface 110 may forward any received image requests to the processor 155. If an image request is received, the process 400 may proceed to block 475. Otherwise, the process 400 may return to block 460.

At block 475, the vehicle computer 105 receives an image captured by the camera 115. The processor 155 may output a command signal for the camera 115 to capture an image, and the camera 115 may respond by capturing the image and storing the image in the memory 120. The processor 155 may retrieve the image from the memory 120.

At block 480, the vehicle computer 105 transmits the image to the primary mobile device 135. The processor 155 accesses the image from the memory 120 and instructs the communication interface 110 to transmit the image to the primary mobile device 135. In addition or in the alternative, the image may be transmitted to the remote server 150, which may make the image available via the web app so that it can be accessed via the personal computer 145.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle computer comprising:
a processor programmed to confirm an identity of a limited user prior to permitting the limited user to enter an autonomous host vehicle, monitor autonomous operation of the host vehicle, and transmit a status update to a primary mobile device associated with a supervisor user of the host vehicle during autonomous operation of the autonomous host vehicle.

2. The vehicle computer of claim 1, wherein the processor is programmed to confirm the identity of the limited user based at least on part on messages received, via a communication interface, from a secondary mobile device associated with the limited user.

3. The vehicle computer of claim 1, further comprising a camera programmed to capture images inside the autonomous host vehicle, and wherein a communication interface is programmed to transmit the images to the primary mobile device.

4. The vehicle computer of claim 1, wherein a communication interface is programmed to wirelessly communicate with a remote server storing a supervisor profile associated with the supervisor user and a limited user profile associated with the limited user.

5. The vehicle computer of claim 4, wherein the processor is programmed to control autonomous operation of the host vehicle according to data contained in the limited user profile after confirming the identity of the limited user and permitting the limited user to enter the autonomous host vehicle.

6. The vehicle computer of claim 4, wherein the processor is programmed to determine permissions granted to the limited user based at least in part on the limited user profile, wherein the permissions indicate autonomous operations of the host vehicle that can be adjusted by the limited user via a secondary mobile device associated with the limited user.

7. The vehicle computer of claim 1, wherein the processor is programmed to wait to permit at least one autonomous operation of the host vehicle until approval for the at least one autonomous operation of the host vehicle is received via the primary mobile device associated with the supervisor user.

8. The vehicle computer of claim 7, wherein the at least one autonomous operation of the host vehicle includes at least one of unlocking a door, navigating to a destination, developing a route to the destination, and changing the destination.

9. The vehicle computer of claim 1, wherein the status update indicates that the autonomous host vehicle has arrived at a destination.

10. The vehicle computer of claim 1, wherein the status update indicates that the autonomous host vehicle has arrived at a pickup location.

11. The vehicle computer of claim 1, wherein the status update indicates that the limited user has entered the autonomous host vehicle.

12. The vehicle computer of claim 1, wherein the status update indicates a number of occupants detected in the autonomous host vehicle.

13. A method comprising:
confirming an identity of a limited user prior to permitting the limited user to enter an autonomous host vehicle;
monitoring autonomous operation of the host vehicle; and
transmitting a status update to a primary mobile device associated with a supervisor user of the host vehicle during autonomous operation of the autonomous host vehicle.

14. The method of claim 13, wherein confirming the identity of the limited user includes confirming the identity of the limited user based at least on part on messages received at the autonomous host vehicle from a secondary mobile device associated with the limited user.

15. The method of claim 13, further comprising:
capturing images inside the autonomous host vehicle; and
transmitting the images to the primary mobile device.

16. The method of claim 13, further comprising:
requesting a supervisor profile and a limited user profile stored on a remote server, wherein the supervisor profile is associated with the supervisor user and the limited user profile is associated with the limited user;
determining permissions granted to the limited user based at least in part on the limited user profile; and
controlling autonomous operation of the host vehicle according to data contained in the limited user profile after confirming the identity of the limited user and permitting the limited user to enter the autonomous host vehicle, wherein the permissions indicate autonomous operations of the host vehicle that can be adjusted by the limited user via a secondary mobile device associated with the limited user.

17. The method of claim 13, further comprising waiting to execute at least one autonomous operation of the host vehicle until approval for the at least one autonomous operation of the host vehicle is received via the primary mobile device associated with the supervisor user.

18. The method of claim 17, wherein the at least one autonomous operation of the host vehicle includes at least one of unlocking a door, navigating to a destination, developing a route to the destination, and changing the destination.

19. The method of claim 13, wherein transmitting the status update includes transmitting the status update when at least one of:
the autonomous host vehicle has arrived at a destination,
the autonomous host vehicle has arrived at a pickup location, and
the limited user has entered the autonomous host vehicle.

20. The method of claim 13, wherein the status update indicates a number of occupants detected in the autonomous host vehicle.
